(19) United States
(12) Patent Application Publication
(10) Pub. No.: US 2004/0083123 A1
(43) Pub. Date: Apr. 29, 2004

(54) System for managing medical insurance using information communication network

(76) Inventors: Seong-Soo Kim, Seoul (KR); Byung-Gu Kang, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 10/470,688

(22) PCT Filed: Feb. 1, 2002
(86) PCT No.: PCT/KR02/00151

(30) Foreign Application Priority Data
Feb. 2, 2001 (KR) 2001/5039
May 7, 2001 (KR) 2001/24584

(51) Int. Cl. G06F 17/60

(52) U.S. Cl. 705/2; 705/4

(57) ABSTRACT

A medical insurance control system and method thereof using medical insurance electronic recording medium and communication networks applicable with a smart medium card stored with individual history information and medical insurance related information on medical insurance beneficiary and on-line access information, the card being used to make an on-line information access to check medical treatment history of the relevant medical insurance beneficiary and to allow a medical institution to immediately request medical insurance premium and medical treatment fee (patients burden) on-line and have same certified in payment, wherein the medical insurance card holder can be confirmed as a legitimate medical insurance beneficiary by the medical insurance management system when receiving medical treatments in hospitals and clinics to thereby efficiently prevent medical institutions from making false and unlawful requests or medical insurance beneficiaries from making a non-payment for a long time, wherein the medical insurance electronic recording medium includes an on-line settlement function so that it is possible to make an instant payment at medical institutions for medical fee (to be paid by patient), thereby improving convenience for medical insurance beneficiaries.

### BACKGROUND OF THE INVENTION

1. Field of the Invention

The present invention relates to a medical insurance management system and method thereof adapted to use communication networks and medical insurance electronic recording medium for electronically storing information on medical insurance cards to thereby process medical insurance and treatment records, and more particularly to a medical insurance management system and method thereof using medical insurance electronic recording medium and communication networks adapted to controllably store various information necessary for usage of medical insurance and to utilize the medical insurance electronic recording medium, thereby enabling to process medical insurance premiums and medical fees on the communication networks and integrated control, and operation of medical treatment records on-line.

2. Brief Description of the Prior Art

In general, in a state where medical insurance cards are issued off-line from medical insurance company, when a predetermined medical insurance beneficiary pays monthly or quarterly the medical insurance premiums individually allocated from the medical insurance company. Various hospitals/clinics and medical treatment institutions can provide insurant with medical fee benefits against medical treatment and prescriptions according to insurant's disease utilizing the medical insurance card.

In other words, under the current medical insurance system, when various hospitals/clinics and medical treatment institutions affiliated with drug stores treat the medical insurance beneficiaries, part of medical fees allocated in return for medical treatment is requested from the medical insurance company and balance of the medical fees is burdened by the medical insurance beneficiaries, where the medical insurance company uses as financial resources the medical fees periodically paid by the medical insurance beneficiaries according to medical insurance cards issued by the medical insurance company to shore up part of medical fees except for individual share of allotment, by which economic burden according to medical treatment given to the medical insurance beneficiaries can be reduced and more effective medical system can be established.

Recently due to the separation of pharmacy and clinic, amount of medical fees is on the increase, such that time is matured to practice management of objective and transparent medical insurance in terms of supply and demand in response to the on-going trend of increasing medical fees.

However, there is a problem in the current medical insurance system thus described in that although medical practices are always available where patient's history not treated may be used by hospitals/clinics or medical institutions affiliated with drug store, or excessive medical fees are unlawfully requested by the same utilizing practices of unnecessary treatment or addition of improper prescription, it is very difficult to accurately ascertain detailed medical-fees on the part of the medical insurance company and there may occur excessive request of medical fees or full payment of the excessively requested medical fees from the medical insurance company, resulting in a chronic successive deficit on the part of the medical insurance company and making the medical insurance beneficiaries periodically pay increased medical fees to the detriment of same.

There is another problem in the current off-line medical insurance system thus described in that it is impossible for the medical insurance beneficiaries to check his or her own medical history thoroughly to thereby make individual or family health care controls unsystematic such that the medical insurance beneficiaries cannot get information on whether their medical insurance charges are correctly fixed, only to be left to indifference to the medical insurance burden and to hold grudges and complaints against the overall medical insurance system.

### SUMMARY OF THE INVENTION

The present invention is disclosed to solve the aforementioned problem and it is an object of the present invention to provide a medical insurance electronic recording medium adapted to electronically store on-line access information for use in medical insurance of medical insurance beneficiary and individual history information and medical treatment record information, and to allow medical treatment to be performed by a medical institution utilizing medical insurance benefit through the on-line access information.

It is another object of the present invention to provide a medical insurance management system and method thereof using information communication network adapted to utilize medical insurance electronic recording medium possessed by medical insurance beneficiary to allow the medical institution to immediately request medical insurance premium and medical treatment fee (patient's burden) on-line and to have same certified in payment.

It is still another object of the present invention to provide a medical insurance management system and method thereof using information communication networks adapted to generally control the medical insurance status and medical treatment record of medical insurance beneficiaries issued by the medical insurance electronic recording medium and to use the medical insurance electronic recording medium owned by the medical insurance beneficiaries to allow the medical institutions to check on-line the medical treatment records of relevant medical insurance beneficiaries.

It is further another object of the present invention to provide a medical insurance management system and method thereof using information communication networks adapted to utilize the medical insurance status of medical insurance beneficiaries and comprehensive control data of medical treatment data issued by medical insurance electronic recording medium for use as medical assistance information necessary for various medicine-related statistics and medical demand and supply.

It is still further another object of the present invention to provide a medical insurance management system and method thereof using information communication networks adapted to allow medical information beneficiary to pay the medical treatment charges (patient's burden) instantly at the medical institutions via on-line payment utilizing the medical insurance electronic recording medium.

In accordance with one object of the present invention, there is provided a medical insurance electronic recording medium, the medium comprising a thin card-type information recording medium mounted with semiconductor memories where medical insurance-related information of predetermined medical insurance beneficiary is so stored as to be read outside.

A system according to one embodiment of the present invention for accomplishing another object of the present invention, the system including:

medical insurance electronic recording medium of a thin card-type information recording medium mounted with semiconductor memories stored with medical insurance-related information, and issued to medical insurance beneficiary;

card reading/writing means for reading information stored in the medical insurance electronic recording medium and for recording medical information of relevant medical insurance beneficiary on related medical insurance electronic recording medium;

medical institution regional terminal for being accessed on-line through information communication networks by medical insurance related information readable by card reading/writing means and for requesting on-line the medical insurance premium and medical fee (to be paid by patient) arranged as a result of treatment on relevant medical insurance beneficiary;

medical insurance management means for allowing an on-line access from the medical institution regional terminal by the medical insurance related information of medical insurance electronic recording medium possessed by the medical insurance beneficiary and requesting payment approval relative to medical insurance premium and medical fee (to be paid by patient) requested as a result of treatment on medical insurance beneficiary of medical institution regional terminal;

information database stored with medical insurance related information of medical insurance beneficiary issued by the medical insurance electronic recording medium; and

a payment approval server for certifying the medical insurance fee and medical fee (to be paid by patient) to relevant medical institution according to payment approval request of medical fee relative to medical institution regional terminal from the medical insurance management means.

In accordance with another object of the present invention, there is provided a medical insurance management method using a medical insurance electronic recording medium and communication networks, the method comprising the steps of:

utilizing a medical insurance related information stored in a medical insurance electronic recording medium possessed by a medical insurance beneficiary to allow a medical institution regional terminal to be accessed to a medical insurance management system through the information communication networks;

requesting medical insurance premium and medical fee (to be paid by patient) allocated as a result of treatment to the medical insurance management system while the, medical institution regional terminal is in connection with the system;

processing a payment approval of medical insurance premium and medical fee (to be paid by patient) requested from the medical insurance management system to the medical institution regional terminal;

paying the medical insurance premium approved in payment by medical insurance management corporations at the payment approval process step at a prescribed date to a relevant medical institution and requesting the payment-certified medical fee (to be paid by patient) to medical insurance beneficiary to pay the received medical fee (to be paid by patient) to relevant medical institution.

In accordance with still another object of the present invention, there is provided a medical insurance management system using medical insurance electronic recording medium and communication networks for comprehensively storing and controlling medical record information in relation to treatment results of various medical insurance beneficiaries, the system comprising:

a plurality of server means, each mounted at various fields of medical related special institutions and business, for on-line requesting statistical and analytical data made on medical insurance beneficiaries and receiving on-line the, statistical and analytical data via information communication network for storage thereof;

medical insurance managing means for making various fields of statistical and analytical data on the basis of the medical treatment records resulted from the medical treatment practices on the plurality of medical insurance beneficiaries and transmitting on-line the statistical and analytical data via the information communication network according to the information requests from the plurality of server means;

computer terminal for making various fields of statistical and analytical data on the basis of the medical treatment records resulted from medical treatments on a plurality of medical insurance beneficiaries under the management of medical insurance managing means; and

information databases for storing and managing the various fields of statistical and analytical data made by the computer terminal.

### BRIEF DESCRIPTION OF THE DRAWINGS

Objects and aspects of the invention will become apparent from the following description of preferred embodiments with reference to the accompanying drawings in which:

FIG. 1 is a conceptual view for schematically illustrating medical insurance and treatment records related information processing flow of medical insurance management system using communication network in accordance with an embodiment of the present invention;

FIG. 2 illustrates a structure of a medical insurance management system using communication network in accordance with an embodiment of the present invention;

FIG. 3 illustrates a structure of the smart medium medical insurance card illustrated in FIG. 2;

FIG. 4 illustrates an instance for medical treatment record information details to be inquired as a result of medical insurance and treatment related information processing steps in accordance with a preferred embodiment of the present invention;

FIG. 5 illustrates data flow for processing medical treatment records and medical insurance related information through information communication network by using the smart medium medical insurance card shown in FIG. 2;

FIG. 6 illustrates a structure of a medical insurance management system using communication network in accordance with another embodiment of the present invention;

FIG. 7 illustrates a structure of a medical insurance management system using communication network according to still another embodiment of the present invention;

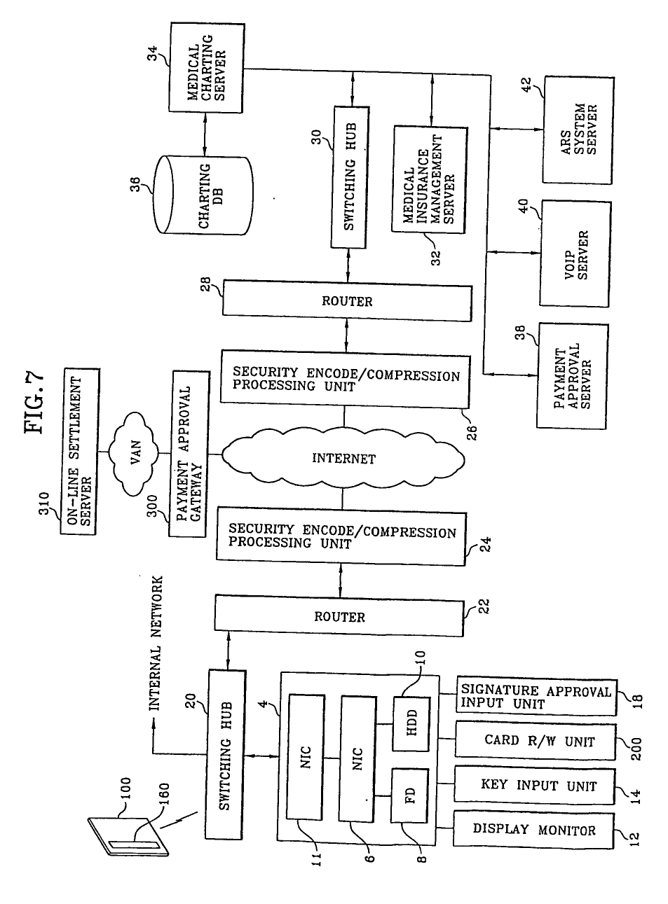

FIG. 8 illustrates a structure of the smart medium medical insurance card shown in FIG. 7; and

FIG. 9 illustrates data flow for making payment transactions on medical fees by utilizing the smart medium medical insurance card shown in FIG. 7.

### DETAILED DESCRIPTION OF THE INVENTION

Hereinafter, preferred embodiments of the present invention will be described with reference to accompanying drawings.

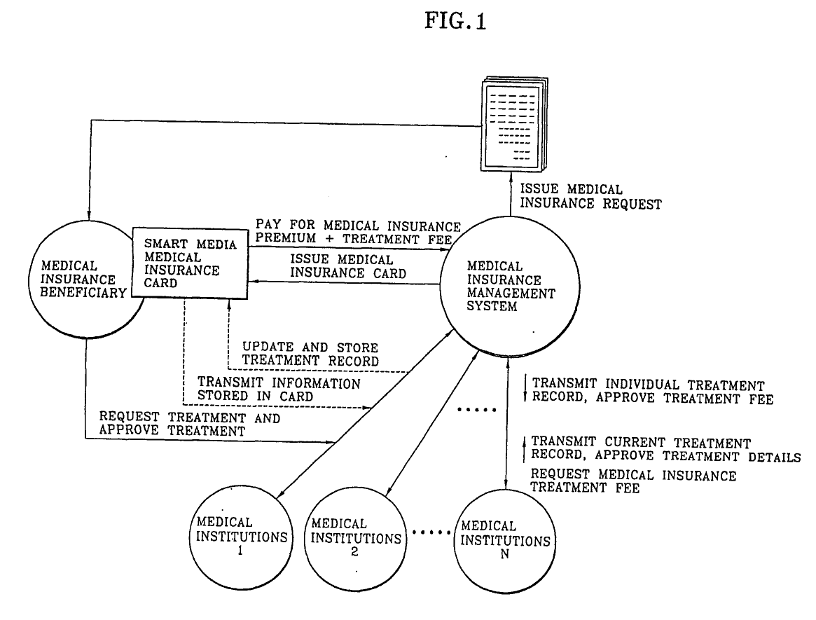

FIG. 1 is a conceptual view for schematically illustrating medical insurance and treatment related information processing flow of medical insurance management system using communication network in accordance with an embodiment of the present invention.

As shown in FIG. 1, according to a medical insurance management system of the present invention, a medical insurance beneficiary receives a smart medium medical insurance card stored with medical insurance access information and personal information by a medical insurance management system and uses the smart medium medical insurance card to get necessary medical treatments from a plurality of medical service providers.

At this time, the plurality of medical treatment service providers cover a wide range of western and oriental styles of medical institutions including hospitals, clinics and municipal-, provincial- and community-based health care providers and drug stores across the nation.

It is possible that the plurality of medical treatment related institutions provide medical treatment and medicine prescription and preparation services for any medical insurance beneficiary holding the smart medium medical insurance card. If the medical insurance management system is connected on-line via information communication network, like internet for instance, the medical insurance beneficiary can get connected with the medical insurance management system on-line through the medical insurance access information of his or her own smart medium medical insurance card and request medical insurance premium (part to be charged by medical insurance out of total medical treatment payment) and medical treatment fee (to be paid by patient).

The medical insurance management system includes databases constructed to entirely manage all the medical treatment records on medical insurance beneficiaries who have received the smart medium medical insurance card. When an on-line access inquiry is made by the plurality of medical treatment institutions with medical insurance beneficiary's smart medium medical insurance cards, an individual treatment history records about the relevant medical insurance beneficiary can be transmitted via on-line. Also, when medical insurance premium and medical treatment fee (to be paid by patient) are requested by the plurality of medical treatment institutions, the medical insurance premium is immediately endorsed and the medical treatment fee (to be paid by patient) is requested with an issuance of an invoice on a pre-agreed date to the medical insurance beneficiary.

However, the medical insurance management system is to settle the medical insurance premium and medical treatment fee (to be paid by patient) requested by medical treatment service providers only when payment approval information on listed treatment details is received from relevant medical institutions according to the approval of final treatment results with a list of information recorded on the smart medium medical insurance card after the medical insurance beneficiary receives a plurality of medical treatment services from the plurality of medical institutions by using the smart medium medical insurance card.

Furthermore, medical insurance management corporations that handle medical insurance policies using the medical insurance management system pay medical insurance premiums and treatment fees taken from medical insurance beneficiaries as the payment approval is made to medical institutions on pre-agreed dates. At this time, the payments are made as previously agreed between the medical insurance management corporations and medical service providers like depositing money on-line to specifically designated accounts.

On the other hand, the plurality of medical institutions can perform medical practices and prescriptions and preparations of medicine with reference to individual medical treatment records received by the medical insurance management system. The medical treatment records on the medical insurance beneficiary currently added as a result from all the medical treatment related practices are transmitted on-line to the medical insurance management system via information communication network for further management.

Meanwhile, according to an embodiment of the present invention, a function to be used as on-line payment means (for instance, a credit card or the like) can also be included in the smart medium medical insurance card that makes an on-line payment easy and convenient, so that the medical insurance beneficiary can make an instant payment for the medical fees with the on-line payment means of the smart medium medical insurance card as he or she wishes.

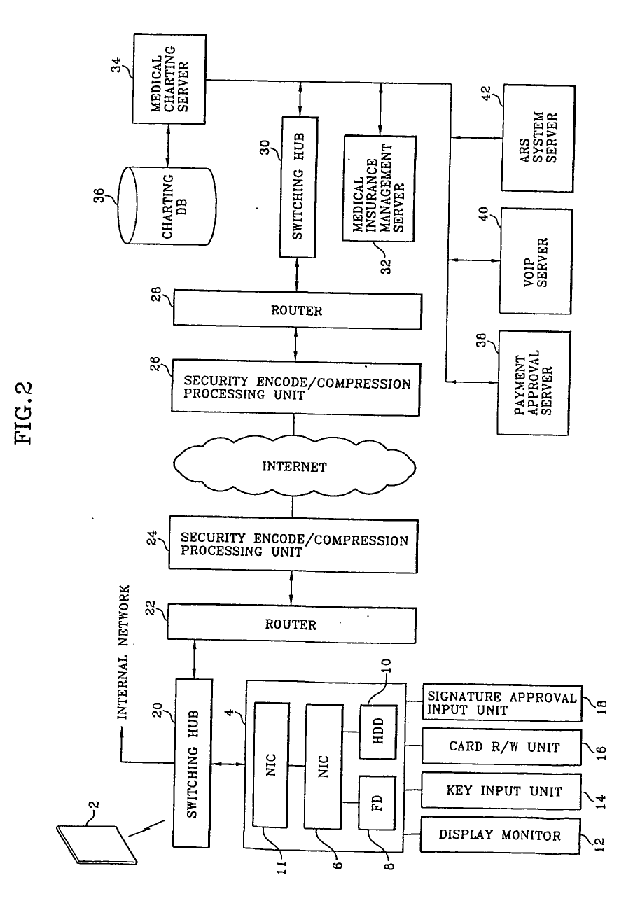

FIG. 2 illustrates a structure of a medical insurance management system using communication network in accordance with an embodiment of the present invention.

As shown in FIG. 2, the medical insurance management system of the present invention includes: a smart medium medical insurance card 2 belonging to a medical insurance beneficiary; a medical institution regional terminal 4 installed in a plurality of medical institutions; display monitor 12, key input unit 14, card reading/writing unit 16 and signature approval input unit 18 connected with the medical institution regional terminal 4 and hub 20, router 22, security encode/compression processing unit 24 for getting internal private network connected with an internet as on-line information network.

On the other hand, the medical insurance management system includes: a security encode/compression processing unit 26, router 28, switching hub 30 to get connected with the medical institution regional terminal 4 via internet; medical insurance management server 32; medical charting server 34; charting database 36; payment approval server 38; VOIP server 40 and ARS system server 42.

In the same drawing, the smart medium medical insurance card 2 transmits information recorded on the card to the medical institution regional terminal 4 by the operations of reading/recording card information of the card reading/writing unit 16 and also stores updated individual medical treatment history information received by the medical insurance management server 32 via internet. The smart medium card 2 is made of a thin card-type information record medium embedded with semiconductor memory and control processing chips with a function of reading and recording the stored information in a contact or non-contact method.

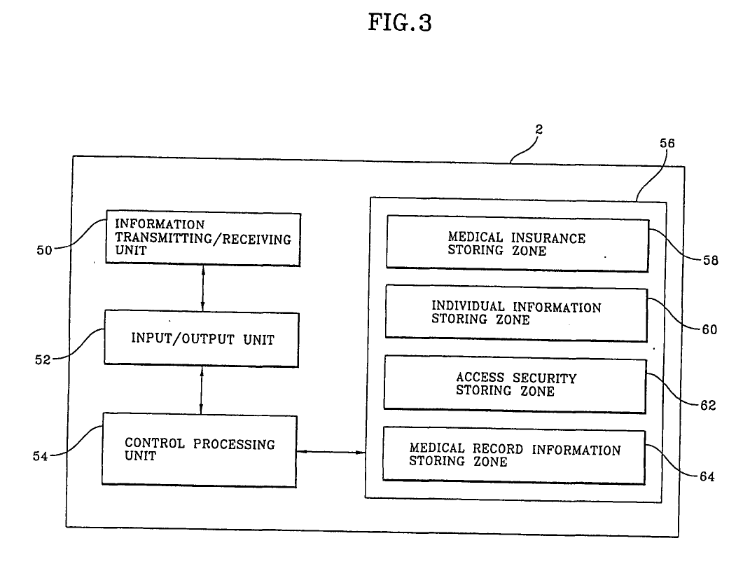

The smart medium medical insurance card 2 is, as shown in FIG. 3, constructed with information transmitting/receiving unit 50, input/output unit 52, control processing unit 54 and information storing unit 56. At this time, the information transmitting/receiving unit 50 is made of a contact type of data transmitting/receiving terminal, thereby transmitting the information recorded in the information storing unit 56 to the card reading/writing unit 16 and, at the same time, receiving the updated medical treatment record information from the card reading/writing unit 16.

At this time, the information transmitting/receiving unit 50 is made of an antenna embedded on the surface of the relevant smart medium medical insurance card 2, making it possible to transmitting/receiving related information wirelessly in a non-contact method.

In FIG. 3, the input/output unit 52 of the smart medium medical insurance card 2 transmits the information recorded and stored in the information storing unit 56 to the information transmitting/receiving unit 50 under the input/output control of the control processing unit 54 and, at the same time, stores the medical treatment information received from the information transmitting/receiving unit 50 to the information storing unit 56. The control processing unit 54 reads the information recorded and stored in the information storing unit 56 according to the control communications of the card reading/writing unit 16 via the information transmitting/receiving unit 50 and, at the same time, controls to store the medical treatment information received from the card reading/writing unit 16 at the relevant information storing unit 56.

Besides, the information storing unit 56 includes: a medical insurance information storing zone 58 where medical insurance related information allocated to medical insurance beneficiary subscribing medical insurance is stored; an individual information storing zone 60 where individual information on single or plural beneficiaries using the relevant smart medium medical insurance card 2 is stored; an access security information storing zone 62 where access security information to make an access to the medical insurance management system on-line via internet is stored; and medical record information storing zone 64 where updated medical treatment records on the medical insurance beneficiary is stored.

On the other hand, as shown in FIG. 2, the medical institution regional terminal 4 is constructed with CPU 6, flash memory disc 8, hard disc drive 10 and network interface card 11 having a LAN card. The medical institution regional terminal 4 is embedded with an exclusive web browser program that allows transmission and reception of internet web information data under the window or Linux operating system and on-line software program that allow inquiry and record of medical treatment details and transmission of information, thereby making it possible to make an on-line internet access by using the smart medium medical insurance card 2 through the card reading/writing unit 16, inquiring individual medical treatment history information via internet as an information access is made by using the smart medium medical insurance card 2 to transmit the medical treatment history recorded and approved by medical insurance beneficiary with his or her autograph to the medical insurance management system.

At this time, the flash memory disc 8 includes fire proof means to secure safety and tenacity for communication access processes with the medical insurance management server 32 via internet under window or Linux operating system, an information reading/recording step of the card reading/writing unit 16 and a signature approval step of the signature/approval input unit 18. At this time, the memory disc 8 thus constructed can restrict accessibility for only users who know a specifically assigned secret code.

In addition, the display monitor 12 is connected with the medical institution regional terminal 4 to visually check on-line information access status, medical treatment record information inquiring status, medical treatment result signature approving status and medical treatment and medicine prescription and preparation status by using the smart medium medical insurance card 2.

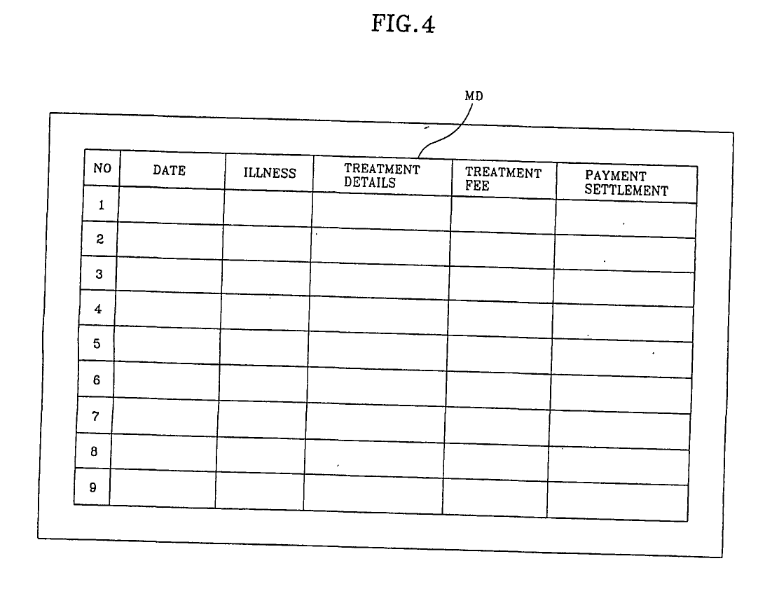

At this time, if individual medical treatment history details on a predetermined medical insurance beneficiary provided by the medical insurance management server 32 is received for inquiry, the display monitor 12 shows all medical treatment history information covering medical treatment details such as medical treatment date, illness name, medicine prescription, treatment fee, payment result on the display monitor 12 as shown in FIG. 4. Then, the relevant medical institution performs medical treatments and medicine prescriptions and preparations with reference to the medical treatment details.

The key input unit 14 is constructed with key board and mouse connected with the medical institution regional terminal 4 to perform a key input for an input manipulation in search for various medical treatment records and a list of medical treatment information.

Furthermore, the card reading/writing unit 16 is connected with the information transmitting/receiving unit 50 of the smart medium medical insurance card 2 to read out the information enlisted under the relevant card and perform a recording operation to store the updated medical treatment record in the information storing unit 56 of the relevant smart medium medical insurance card 2.

The signature approval input unit 18 is constructed with an electronic pen and a touch pad to write down a signature of the medical insurance beneficiary for approval of medical treatments.

Moreover, the switching hub 20 is connected with internal network of medical institution regional terminal 20 and relevant medical institutions via a plurality of ports to perform switching distributions of internet information data transmitted/received through internet. The router 22 performs a network management function of enabling the medical institution regional terminal 4 and medical insurance management server 32 to make the same protocol information communications through internet.

Furthermore, the security encode/compression processing unit 24 encodes information data to be outputted from the medical institution regional terminal 4 according to pre-agreed encoding algorithm, compresses it into a small amount of data and transmits it through internet. The security encode/compression processing unit 24 also decodes and de-compresses the file data encoded, compressed and received through internet according to pre-agreed encoding algorithm.

As shown in FIG. 2, the security encode/compression processing unit 26 encodes information data to be transmitted from the medical insurance management sever 32 to the medical institution regional terminal 4 according to pre-agreed encoding algorithm, compresses it into a small amount of data and transmits it through internet. The security encode/compression processing unit 26 also decodes and de-compresses the file data encoded, compressed and received through internet according to pre-agreed encoding algorithm.

On the other hand, the router 28 performs a network management function of enabling the medical institution regional terminal 4 and medical insurance management server 32 to make the same protocol information communications through internet, and the switching hub 30 makes switching distributions of information data transmitted and received through internet to the medical insurance management server 32.

In the same drawing, when an information access is made by the medical institution regional terminal 4 via internet with a smart medium medical insurance card 2, the medical insurance management server 32 transmits on-line individual medical treatment history information on medical insurance beneficiary to the relevant medical institution regional terminal 4 for inquiry. When the medical insurance management server 32 receives medical treatment triggered information and signature and approval information after all the medical treatments and medicine prescriptions and preparations are made on the medical insurance beneficiary, all the medical treatment information received along with the signature approved by the medical insurance beneficiary is stored at the charting database 36 and further transmitted for storage at the smart medium medical insurance card 2 as updated medical treatment information.

Also, when a request is made by the medical institution regional terminal 4 for medical insurance premium and medical fee (to be paid by patient), the medical insurance management server 32 makes a credit inquiry and a payment request to the payment approval server 38 with reference to the resultant medical treatment information stored at the charting database 36.

On the other hand, the medical charting server 34 provides medical treatment related information stored at the charting database 36 and renews and stores the updated medical history information on the basis of medical insurance information and individual information supplied by information access of the smart medium medical insurance card 2 according to the control communication with the medical insurance management server 32.

The charting database 36 stores various medical insurance and medical treatment record related information including personal information, individual access security information, medical treatment records and current status of medical insurance premium payment of all medical insurance beneficiaries to whom the smart medium medical insurance card 2 is issued.

In the same drawing, upon a payment approval request of the medical insurance management server 32 for the medical insurance premium and medical treatment fee (to be paid by patient) to medical institutions, the payment approval server 38 makes a payment settlement on the requested medical insurance premium and medical treatment fee (to be paid by patient) after the credit inquiry process is made with servers of financial institutions to which relevant medical institutions have transactions.

The VOIP server 40 is to perform a function of answering questions on various medical insurance and medical treatment records related information through internet telephone communications with medical insurance beneficiaries possessing the smart medium medical insurance card 2 or with employees of the medical institutions.

The ARS system server 42 is to provide medical insurance and medical treatment record related information for medical insurance beneficiaries or employees of medical institutions that get connected by a general telephone system through a public telecommunication network system using an automatic voice response system.

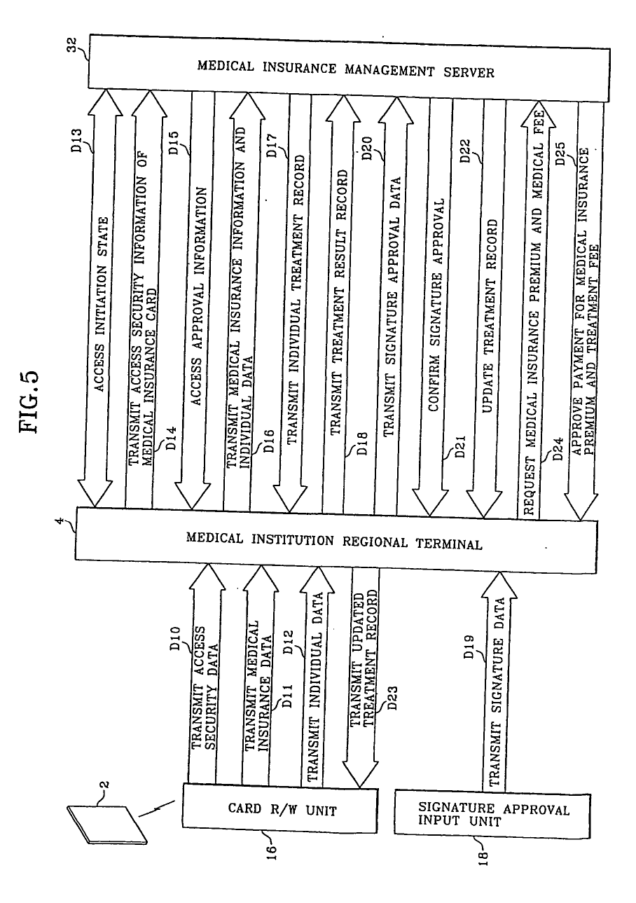

Accordingly, operations of the present invention thus constructed will be described in detail with reference to the data flow chart shown in FIG. 5,

First of all, when a medical insurance beneficiary possessing a smart medium medical insurance card 2 pays a visit to a predetermined medical institution and information recorded on the relevant smart medium medical insurance card 2 is read out by the card reading/writing unit 16, the card reading/writing unit 16 reads the access security data D10 stored at the information storage unit 56 of the smart medium mediuml insurance card 2 and transmits it to the relevant medical institution regional terminal 4. At this time, the medical insurance data D11 and individual data D12 are also transmitted to medical institution regional terminal 4.

Then, while the medical institution regional terminal 4 keeps its initiation state of data D13 access with the medical insurance management server 32 through internet, it receives access security information of the smart medium mediuml insurance card 2 read by the card reading/writing unit 16 and transmits it to the medical insurance management server 32 as access security data D14 of the medical insurance card. At this time, the relevant medical insurance management server 32 transmits data D15 to approve the access security information received by the medical institution management regional terminal 4.

Then, the medical institution regional terminal 4 transmits the medical insurance and individual data D16 of the smart medium medical insurance card 2 read by the card reading/writing unit 16 to the medical insurance management server 32, and the relevant medical insurance management server 32 transforms individual mediuml information details D17 of the medical insurance-beneficiary from information stored at the charting database 36 into a reference type of information that can be inquired by the medical institution regional terminal 4 for transmission.

On the other hand, the medical institution having the regional terminal 4 makes required medical treatments and medicine prescriptions and preparations for the medical insurance beneficiary possessing the medical insurance card 2 with reference to the medical records of the medical treatment information details (MD: refer to FIG. 4) shown on the display monitor 12. The resultant medical practices are input by the key input unit 14 to store at the hard disc drive 10 of the relevant regional terminal 4.

Next, the medical institution regional terminal 4 transmits the updated medical treatment record information D18 on the relevant medical insurance beneficiary whose information is input by the key input unit 14 to the medical insurance management server 32 via internet, and it becomes possible for the relevant medical insurance beneficiary to check the updated medical treatment information on the display monitor 12 as inquired.

When the medical insurance beneficiary inputs his or her own signature on the signature/approval input unit 18 to confirm the medical treatment record details, the medical institution regional terminal 4 transmits the signature approval data D20 input by the signature approval input unit 18 to the medical insurance management server 32 via internet.

When the medical insurance management server 32 determines that the signature approval information of the medical insurance beneficiary transmitted by the medical institution regional terminal 4 is identical to previously registered signature data, it transmits the confirmed signature approval data D21 to the relevant medical institution regional terminal 4 and, at the same time, the medical charting server 34 renews and stores the final medical treatment record information received from the medical institution regional terminal 4 in the charting database 36. Further, the final medical treatment record information is transmitted to the medical institution regional terminal 4 as the updated medical treatment record data D22.

As a result, the medical institution regional terminal 4 drives the card reading/writing unit 16 to record the updated medical treatment information received by the medical insurance management server 32 at the smart medium medical insurance card 2 for storage.

However, if there is an inevitable information error on the internet, the medical institution regional terminal 4 may store the medical treatment information that has stored in the hard disc drive 10 as updated medical treatment information in the information storing unit 56 of the smart medium medical insurance card 2.

Next, the medical institution regional terminal 4 asks for payment by transmitting the payment request data D24 on the medical insurance premium and medical fee (to be paid by patient) estimated according to all the medical treatment practices onto the medical insurance beneficiary like medical treatments and medicine prescriptions and preparations via internet. The medical insurance management server 32 gets connected with the payment approval server 38 to request a payment approval on the medical insurance premium and medical fee inquired by the medical institution regional terminal 4.

Accordingly, the payment approving server 38 performs the payment approval process on the medical insurance premium and medical fee requested by the medical insurance management server 32 after an on-line credit inquiry step is made to a financial institution that carries out money transactions with the relevant medical institution.

Next, another embodiment of the present invention will be described in detail with reference to accompanying drawings.

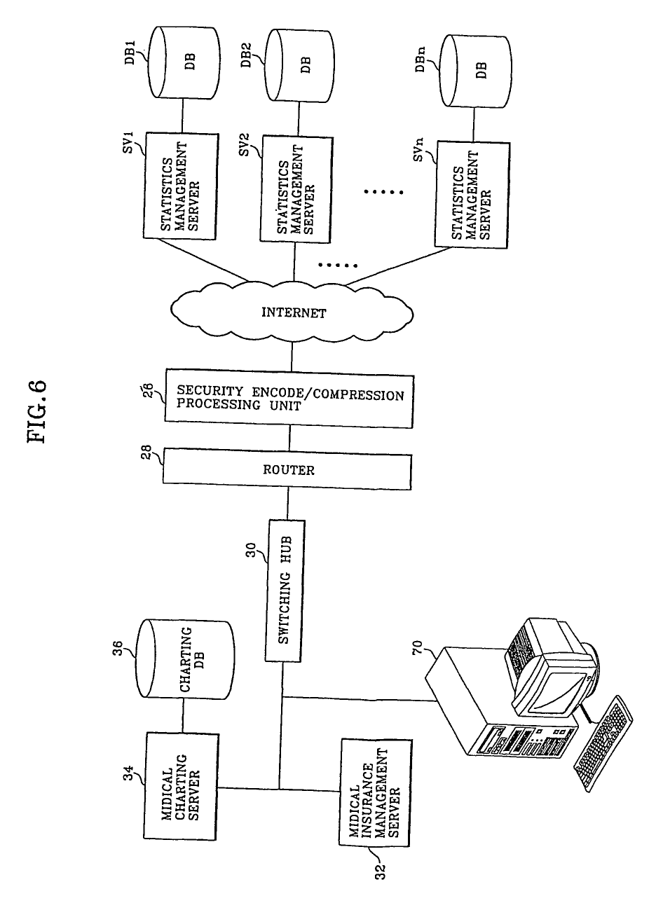

In other words, FIG. 6 illustrates a structure of a medical insurance management system using telecommunication network in accordance with another embodiment of the present invention.

As shown in FIG. 6, when a plurality of medical insurance beneficiaries possessing smart mediuml medical insurance cards 2 receive medical treatments and medicine prescriptions and preparations from various medical institutions (in other words, hospitals/clinics, drug stores and so on) and the medical treatment record is received from the medical institutions, various fields of statistical and analytical data are made on the basis of the medical treatment information on medical insurance beneficiaries and then stored at the charting database. Thus, it becomes possible to provide the stored various statistical and analytical data information for the related institutions and corporations through internet.

In the same drawing, the medical insurance management system is constructed with medical insurance management server 32, medical charting server 34, charting database 36, management computer terminal 70, switching hub 30, router 28, security encode/compression processing unit 26, a plurality of statistics management servers (SV1˜SVn) and a plurality of information databases (DB1˜DBn).

When the medical insurance management server 32 receives medical treatment record information from medical institutions after a medical insurance beneficiary possessing a smart medium medical insurance card 2 gets medical treatments and medicine prescriptions and preparations from various medical institutions, the relevant medical treatment record information is made into various statiscal and analytical information by the management computer terminal 70 and the medical charting server 34 is driven to store all the information in the charting database 36. When various statistical and analytical data is requested by a plurality of statistics management servers SV1˜SVn, the relevant statistical and analytical data is provided on-line.

The management computer terminal 70 is embedded with an exclusively usable software program to produce statiscal and analytical data. With reference to the medical treatment record information made on the basis of results of the medical treatments on the medical insurance beneficiary, the management computer terminal 70 produces various statistical and analytical data by driving the statistical and analytical data producing software program.

At this time, the various statistical and analytical data produced by the management computer terminal 70 can be properly edited and modified on the basis of characteristic data as relevant institutions and corporations request through the plurality of statistics management servers (SV1˜SVn).

The medical charting server 34 stores the statistical and analytical data on various medical treatment records made by the management computer terminal 70 in the charting database 36 under the control communication with the medical insurance management server 32. The charting database 36 stores statiscal and analytical information properly modified and edited according to the characteristics of the medical treatment information requesting institutions such as medical treatment tools and drug product manufacturers/sellers, medicine related statistical and analytical institutions, hospitals/clinics and drug stores.

In the same drawings, the plurality of statistics management servers (SV1˜SVn) are included in all those institutions such as medical treatment tools and drug product manufacturers/sellers, medicine related statistical and analytical institutions, hospitals/clinics and drug stores. The statiscal and management servers transmit the characteristic data (for instance, prescription and preparation states of relevant medical and medicinal products in case of medical and medicinal product manufacturers) to the medical insurance management server 32 via internet as requested by the relevant institutions and corporations and completes the information transmitting request on statiscal and analytical information relative to the relevant characteristic data.

The plurality of information database DB1˜DBn stores and manages the statistical and analytical data received from the medical insurance management server 32 according to requests of respective statistics management servers SV1˜SVn. At this time, the various statistical and analytical data strode in the plurality of information databases DB1˜DBn can be widely used for practical decision-making on production/sale of medical tools, medicinal products and medical policy developments after particularly edited statistical and analytical processes are made according to characteristics of the relevant institutions and corporations.

On the other hand, in order to decode and de-compress the information encoded and compressed by the encoding and data compressing function of the security encode/compression processing unit 26 in connection with the medical insurance management server 32, a plurality of statistics management servers SV1˜SVn can have security encode/compression processing unit (not shown) that includes encoding algorithm previously agreed with relevant security encode/compression unit 26.

Then, operations of the other embodiment of the present invention thus constructed will be described in detail with reference to accompanying drawings.

First of all, when all the medical treatment record information is made as a result of medical treatments and medicine prescriptions and preparations by the medical institutions on a medical insurance beneficiary possessing a smart medium medical insurance card 2 and received on-line, the management computer terminal 70 produces various statiscal and analytical data on the basis of the relevant medical treatment record information, the medical insurance management server 32 stores all the information produced by the management computer terminal 70 in the charting database 36 via the medical charting server 34.

Then, the plurality of statistics management servers SVISVn inquire statistical and analytical data from the medical insurance management server 32 in consideration of characteristics of the relevant institutions and corporations and transmit the correspondingly edited special data. The medical insurance management server 32 receives all the information requests from the statistics management servers SV1˜SVn through the security encode/compression processing unit 26, router 28, and switching hub 30 and extracts the statistical and analytical data adequate to the characteristics of the relevant institutions and corporations out of all the information stored in the charting database 36 to transmit to the relevant statistics management server through internet.

On the other hand, when there is no statistical and analytical data available in the charting database 36, the medical insurance management server 32 notifies the search result that there is no statistical and analytical data having the requested characteristics to the management computer terminal 70.

Then, the management computer terminal 70 produces various statistical and analytical data having characteristics that do not exist in the charting database 36 by driving the statistical and analytical data producing software program. Then, the various statistical and analytical data produced by the management computer terminal 70 are stored at the charting database 36 and then transmitted to the relevant statistics management server through internet.

The statistics management servers SVISVn store all the statistical and analytical data received from the medical insurance management server 32 in information databases DB1˜DBn. At this time, the various statistical and analytical data stored in the plurality of information databases DB1˜DBn can be widely used for taking the following measures on production/sale of medical tools, medicinal products and medical policy developments by the relevant institutions and corporations having the statistics management servers SV1˜SVn.

On the other hand, according to another embodiment of the present invention, it is possible for a medical insurance beneficiary to make an immediumte payment on medical treatment fee (to be paid by patient) through on-line settlement system at medical institutions if the medical insurance smart card includes information on the on-line payment means (for instance, credit card, cash card, money re-charging type card, electronically transacted cyber money, internet transaction accounts and so on).

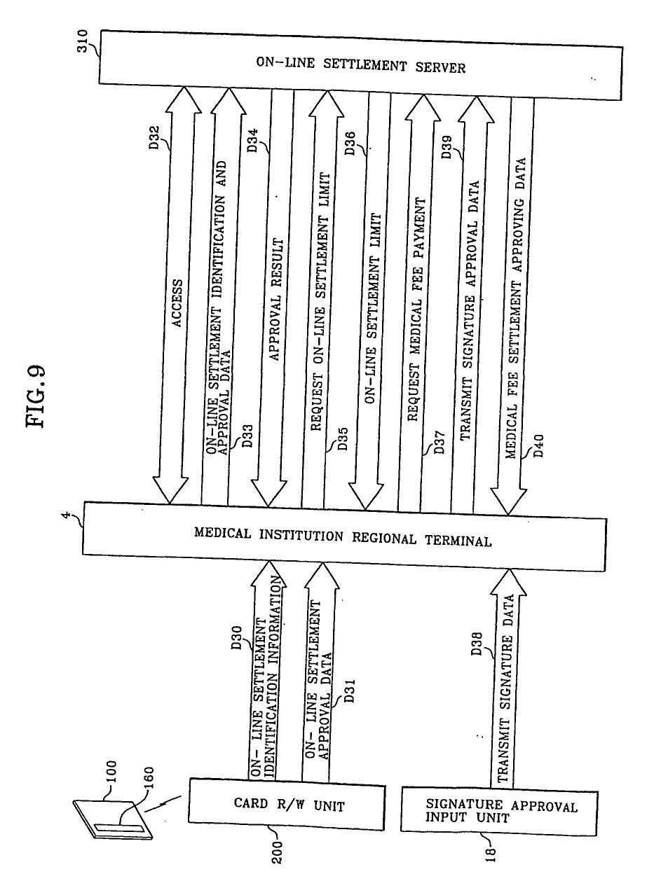

The medical insurance management system using the communication network thus constructed according to another embodiment of the present invention is shown in FIG. 9. In comparison with the medical insurance management system constructed according to the embodiment of the present invention shown in FIG. 2, there is a difference in the structure of smart medium medical insurance card and card reading/writing unit with addition of payment approval gateway 300, value added network VAN and on-line settlement server 310.

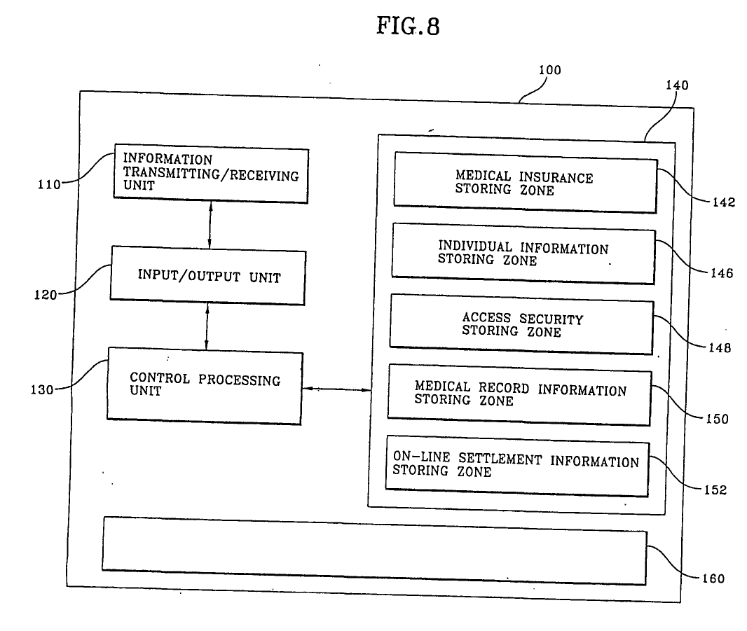

As shown in FIG. 8, the smart medium medical insurance card 100 constructed in accordance with another embodiment of the present invention includes information transmitting/receiving unit 110, input/output unit 120, control processing unit 130, information storing unit 140 and magnetic recording tape 160.

The information transmitting/receiving unit 110 is made of a contact type of data transmitting/receiving terminal, transmitting the information recorded at the information storing unit 140 and receiving the updated medical record information from the card reading/writing unit 16.

At this time, the information transmitting/receiving unit 110 can be made of an antenna embedded in the relevant smart medium medical insurance card 2, transmitting/receiving the relevant information wirelessly in a non-contact method.

The input/output unti 120 transmits the information recorded to the information storing unit 140 under the input/output control of the control processing unit 130 and stores the medical treatment information received from the information transmitting/receiving unit 110 in the information storing unit 140. The control processing unit 130 reads the information recorded and stored in the information storing unit 140 according to the control communication with the card reading/writing unit 200 through the information transmitting/receiving unit 110 and performs a control operation to store the medical treatment information received from the card reading/writing unit 16 in the information storing unit 140.

At this time, the information storing unit 140 includes: medical insurance information storing zone 142 to store insurance related information allocated to medical insurance beneficiaries who have bought a medical insurance; an individual information storing zone 146 to store an individual history information on single or plural number of medical insurance beneficiaries who can use the relevant smart medium medical insurance card 100; an access security information storing zone 148 to store access security information necessary to be connected on-line with the medical insurance management system through internet; a medical record information storing zone 150 to store medical record on medical insurance beneficiaries and an on-line settlement information storing zone 160 to store information on the on-line settlement information that can make an electronic settlement through communication network.

The on-line settlement information storing zone 160 also stores identification information (for instance, types of on-line settlement means, unique serial number or the like) to identify the on-line settlement means and approval information to discriminate the authenticity of the on-line settlement means.

For instance, if the on-line electronic settlement means included in the smart medium medical insurance card 100 is a credit card, the settlement means information zone 160 includes identification information like identification code and credit card number to identify a credit card and approval information to discriminate the authenticity of the identification information. The approval information may be a secret code that the medical insurance beneficiaries have selected and registered at the relevant credit card company.

Besides, the magnetic record tape 160 is attached onto the smart medium medical insurance card 100 whose record side includes identification information of the on-line settlement means. For instance, the identification information of the on-line settlement means may be credit card or cash card used by medical insurance beneficiaries.

The card reading/writing unit 200 should basically include the same structure and functions of the card reading/writing unit 16 shown in FIG. 2. It may also include a card reader that can read information recorded at the magnetic record tape 160 attached to the smart medium medical insurance card 100.

The payment approval gateway 300 is a computer apparatus that helps the on-line settlement process in connection with the one line settlement server 310 through the value added network when a payment approval request on the on-line settlement is made by the medical institution regional terminal 4 connected through internet.

The value added network, which provides information users needed on the basis of pre-existing data communication network, is regarded as a new type of an information service providing network that enables information service providers to gain profit with relevant fees by improving added value of the communication network. For instance, the value added network can provide general computer communication services like file transmission, electronic mails or database search and information services in general aspects of life like inquiry on credibility of a credit card.

Operations to make an on-line payment settlement on medical charges with the medical insurance management system constructed in accordance with another embodiment of the present invention will be described with reference to accompanying drawings.

When the medical insurance beneficiaries pay the medical fees (to be paid by patient) through the on-line settlement system with the smart medium medical insurance card 100, the on-line settlement information recorded at the smart medium medical insurance card 100 is read by the card reading /writing unit 200. At this time, the card reading/writing unit 200 reads the identification data D30 and approval data D31 of the on-line settlement means out of the one line settlement information storing zone 152 of the information storing unit 140 of the smart medium medical insurance card 100.

If a card reader is included in the card reading/writing unit 200, the identification data D30 of the on-line settlement means is read from the magnetic record tape 160 of the smart medium medical insurance card 100. At this time, the approval data D31 of the on-line settlement means can be input through the key input unit 14 when a staff member of the medical institution is punched in as the medical insurance beneficiary tells the value data D31. However, the approval data D31 of the on-line settlement means may be restricted as a value that the medical insurance beneficiary can remember (for instance, a secret code of a credit card) and that can be input through the key input unit 14.

Then, the medical institution regional terminal 4 gets connected with the on-line settement sever 310 through internet, payment approval gateway 300 and the value added network D32.

Next, the medical institution regional terminal 4 transmits the identification information and approval data D33 of the on-line settlement means read from the smart medium medical insurance card 100 through internet, payment approval gateway 300 and added value network to the on-line settlement server 310 according to manipulation of a person in charge.

The on-line settlement server 310 differentiates on-line settlement means included in the smart medium medical insurance card 100 with the identification and approval data D33 of the on-line settlement means transmitted by the medical institution regional terminal 4 and approves the authenticity of the one line settlement means for on-line payment settlement. At last, the result data D34 of the identification and approval processes is transmitted to the medical institution regional terminal 4 via value added network, payment approval gateway 300 and internet.

The medical institution regional terminal 4 displays the approval result data D34 of the on-line settlement means transmitted by the on-line settlement server 310 on the display monitor 12. If the approval result data D34 of the on-line settlement means transmitted by the on-line settlement server 310 is proved correct, the medical institution regional terminal 4 transmits a signal D35 requesting an inquiry about the limit of on-line settlement to the on-line settlement server 310 via internet, payment approval gateway 300 and value added network according to manipulation of the person in charge of the medical institution regional terminal 4.

Thus, the on-line settlement server 310 searches the on-line settlement limit of the on-line settlement means included in the smart medium medical insurance card 100 in the database in response to the on-line settlement limit requesting signal D35 transmitted by the medical institution regional terminal 4 and transmits the on-line settlement limit of the on-line settlement means to the medical institution regional terminal 4 via value added network, payment approval gateway 300 and internet.

Then, the medical institution regional terminal 4 displays the on-line settlement limit data D36 transmitted by the on-line settlement server 310 on the display monitor 12. If the on-line settlement limit displayed on the display monitor 12 is over the total medical fee (to be paid by patient) to the medical insurance beneficiary, the person in charge of the medical institution regional terminal 4 inputs the requested amount of the medical fee through the key input unit 14.

Accordingly, the medical institution regional terminal 4 transmits the medical fee (to be paid by patient) payment requesting data D37 including medical fee information inputted by the person in charge to the on-line settlement server 310 via internet, payment approval gateway 300 and value added network.

At this time, if the medical insurance beneficiary writes an autograph through the signature approval input unit 18 to confirm the payment of the medical fee with the on-line settlement means, the medical institution regional terminal 4 transmits the signature approval information D38 input by the signature approval input unit 18 to the on-line settlement server 310 through internet, payment approval gateway 300 and value added network.

Accordingly, if the signature approval information of the medical insurance beneficiary transmitted by the medical institution regional terminal 4 is compared with previously registered signature data and proved to be identical, the on-line settlement server 310 approves the settlement of the requested medical fee (to be paid by patient). As a result, the signature approval information and medical fee settlement approving data D40 are transmitted to the medical institution regional terminal 4 via value added network, payment approval gateway 300 and internet.

Then, the medical institution regional terminal 4 displays the signature approval and medical fee settiment data transmitted by the on-line settlement server 310.

The embodiments of the present invention thus described can be practiced with various modifications without departing from the scope or spirit of the invention. In the aforementioned embodiments of the present invention, a medical insurance beneficiary possessing a smart medium medical insurance card can personally visit a medical institution to get security access, medical service and signature approval with the smart medium medical insurance card through the medical institution regional terminal.

Furthermore, if a tele-medical treatment is performed far from a relevant medical institution by utilizing information communication network like internet, card reading/writing unit and signature approval input unit related to a communication computer terminal installed at a place other than medical institution, where the medical insurance beneficiary can make an access (for instance, medical insurance beneficiary's residential area, community office, shopping center, convenient stores or the like), can be used for settlement of the medical insurance premium and medical fee (to be paid by patient) and signature approval of the medical treatment details.

As described above, the smart medium card where the individual information, medical insurance related information, on-line information connecting information of the medical insurance beneficiaries can be used as a medical insurance card that can inquire all medical treatment history information of the relevant medical insurance beneficiary in connection with on-line information services. Besides, the medical insurance premium and medical fee resulted from a variety of medical treatments can be immediately requested and payment-approved on-line, thereby preventing medical institutions from making unlawfully excessive or false payment requests on medical insurance premium for more transparent and stable management of the medical insurance system. The medical insurance beneficiary can also understand clearly his or her own medical records for a better health management and correctly check payments for medical insurance premium and medical fee.

In addition, various statistical and analytical data can be made on the basis of all the medical records of the medical insurance beneficiaries possessing medical insurance cards and provided for related medical institutions and medical products manufacturers, thereby making it possible to control and manage more efficiently national medical and health related policies and the demand and supply system of medical treatment tools and medical and medicinal products.

Moreover, there is an advantage according to the present invention in that information on the on-line settlement means is included in the smart medium medical insurance card to make an instant payment at medical institutions, thereby improving convenience for medical insurance beneficiaries.

What is claimed is:

1. (cancelled)

2. (cancelled)

3. (cancelled)

4. (cancelled)

5. (cancelled)

6. (cancelled)

7. (cancelled)

8. (cancelled)

9. (amended) A medical insurance management system using a communication network, the system comprising:
A medical insurance electronic recording medium composed of a card-type information recording medium and issued to a medical insurance beneficiary, the medical insurance electronic recording medium including a medical insurance-related information zone where medical insurance-related information allocated to the medical insurance beneficiary, access security information for on-line accessing the medical insurance management system and personal information regarding one or more beneficiaries capable of using a medical insurance card are recorded, and a medical treatment recording information zone where currently updated medical treatment recording information is recorded;
a medical institution regional terminal of pharmacy or medical institution, including card reading/writing means for reading information of the medical insurance electronic recording medium and for writing the currently updated medical treatment recording information transmitted from the medical insurance management system, for on-line accessing the medical insurance management system through the communication network by using the access security information obtained from the medical insurance electronic recording medium to read medical treatment recording information about a relevant medical insurance beneficiary and for transmitting present medical treatment information about the relevant medical insurance beneficiary while on-line demanding payment of a medical insurance premium and medical fee(to be paid by patient) corresponding to the present medical treatment information;
medical insurance management means for allowing an on-line access to the medical institution regional terminal according to the access security information of the medical insurance-related information recorded on the medical insurance electronic recording medium, which is received from the medical institution regional terminal connected through a predetermined communication network, for setting whether inquiry for medical treatment recording information can be accepted from the medical institution regional terminal, for authenticating payment approval for medical insurance premium and medical fee(to be paid by patient), and for transmitting the currently updated medical treatment recording information to be recorded in the medical insurance electronic recording medium to the medical institution regional terminal connected to the communication network;
a payment approval server for certifying the payment approval for relevant medical institution in response to a request for payment approval from the medical insurance management means; and
an information database for storing the medical insurance-related information of the medical insurance beneficiary recorded on the medical insurance electronic recording medium and medical treatment history information containing all the medical treatment information of the medical insurance beneficiary recorded heretofore.

10. (amended) The system as defined in claim 9 wherein the medical institution regional terminal further comprises a signature approval input unit for transmitting a signature of the medical insurance beneficiary to the medical insurance management system so as to allow the medical insurance beneficiary who receives medial treatment to certify relevant medical treatment result details, and the medical insurance management means of the medical insurance management system is to be recording the treatment information and certifying the payment approval according to the signature of the medical insurance beneficiary transmitted from the medical institution regional terminal

11. (amended) The system as defined in claim 9 wherein each the medical institution regional terminal and the medical insurance management means further comprises a security encoding/compression processing unit having an encoding algorithm and a compressing algorithm previously agreed, and
information received and transmitted between the medical institution regional terminal and the medical insurance management means is encoded and compressed or is decoded and decompressed by the security encoding/compression processing unit.

12. (cancelled)

13. (amended) The system as defined in claim 9 wherein the medical insurance management means extracts the medical treatment history information of the relevant medical insurance beneficiary from the information database according to the access security information recorded on the medical insurance electronic recording medium so as to allow on-line inquiry into the medical treatment history information through the medical institution regional terminal.

14. (amended) The system as defined in claim 9 wherein the medical insurance management means further comprises an Internet phone (Voice Over Internet Protocol) server for providing medical insurance-related information and other civil affair information via voice message.

15. (amended) The system as defined in claim 9 further comprising an automatic response system (ARS) server for providing the medical insurance-related information and other civil affair information in the form of voice by way of automatic voice response function.

16. (amended) The system as defined in claim 9 or claim 10 wherein the medical insurance electronic recording medium further include identification and approval information relative to on-line settlement means, the system performs on-line approval with the relevant on-line settlement means according to the identification and approval information read from the medical insurance electronic recording medium in the medical institution regional terminal, so as to perform the on-line settlement of a medical fee(to be paid by patient).

17. (amended) A medical insurance management method using a communication network, the method comprising the steps of: accessing a medical insurance management system by a medical institution regional terminal through an information communication network in accordance with an access security information included in medical insurance-related information stored in a medical insurance electronic recording medium, which is presented by a medical insurance beneficiary and;
transmitting a result of treatment of the medical insurance beneficiary to the medical insurance management system white the medical institution regional terminal is on-line accessing the medical insurance management system, and demanding payment of a medical insurance premium and medical fee(to be paid by patient) allocated as the result of treatment;
storing the result of treatment received from the medical institution regional terminal in an information database in the medical insurance management system as medical treatment history information, processing a payment approval for a demanded medical insurance premium and medical fee(to be paid by patient), and transmitting, latest medical treatment information to be stored as the medical treatment history information for the relevant medical insurance beneficiary of the medical insurance electronic recording medium, to the medical institution regional terminal; and
paying the medical insurance premium and medical fee(to be paid by patient) approved in payment in the step of processing the payment approval by a medical insurance management corporation to a relevant medical institution at a prescribed date.

18. (amended) The method as defined in claim 17 further comprise steps of: requesting the stored medical treatment history information on the relevant medical insurance beneficiary from the medical insurance management system while the medical institution regional terminal is accessing the medical insurance management system; transmitting the stored medical treatment history information on the medical insurance beneficiary to the medical institution regional terminal when the medical insurance management system receive a request for the medical treatment history information from the medical institution regional terminal; and
performing medical treatment by referring to the medical treatment history information on the medical insurance beneficiary transmitted to the medical institution regional terminal from the medical insurance management system.

19. (amended) The method as defined 17 wherein the step of processing a payment approval of the medical insurance premium and medical fee (to be paid by patient) from the medical institution regional terminal further includes a step: determining whether a signature approval information on medical treatment result details of the medical insurance beneficiary is received or not, and allowing payment approval of the medical insurance premium and medical fee(to be paid by patient) if it is determined that the signature approval information is received.

20. (amended) The method as defined in claim 17 further comprising a step of allowing the medical insurance beneficiary to select a payment settlement method prior to perform the step of demanding payment of the medical insurance premium and medical fee, wherein when the medical insurance beneficiary selects the on-line settlement method which is not included in the medical insurance management system, the medical institution regional terminal reads the identification and approval information regarding the on-line settlement means stored in the medical insurance electronic recording medium, performs on-line payment approval through an access to the relevant on-tine settlement means to make a payment for the medical fee(to be paid by patient), and demands payment of only the medical insurance premium except the medical fee(to be paid by patient) from the medical insurance management system.

21. (amended) The method as defined in claim 20 wherein upon the processing of the settlement of the medical fee (to be paid by patient) by the on-line settlement means stored in the medical insurance electronic recording medium, the on-line settlement means receives the signature approval information of the medical insurance beneficiary from the medical regional terminal and carries out settlement approval.

22. (amended) The system as defined in claim 9 further comprising a computer terminal for making statistical and analytical data on the basis of the medical treatment history information resulted from medical treatments ofn a plurality of medical insurance beneficiaries under management of the medical insurance managing means, and an information databases for storing and managing various fields of the statistical and analytical data made by the computer terminal; and the medical insurance managing means on-line transmits the statistical and analytical data according to a request for information by a server which is built in a medical related special institution and an enterprise requesting the medical statistical data.

23. (amended) The system as defined in claim 22 wherein the medical insurance management means receive specific characteristic information on the medical related special institution and enterprise requesting medical-related statistical and analytical data from the medical related special institution and enterprise server, and provide the statistical and analytical data relating to the characteristic information.
